(19) United States
(12) Patent Application Publication
(10) Pub. No.: US 2021/0332910 A1
(43) Pub. Date: Oct. 28, 2021

(54) MICROFLUDIC FLOW RATE REGULATOR

(71) Applicant: Tauyuan Chen, New Taipei (TW)

(72) Inventor: Tauyuan Chen, New Taipei (TW)

(21) Appl. No.: 15/929,289

(22) Filed: Apr. 23, 2020

(51) Int. Cl. F16K 31/50

(52) U.S. Cl. CPC F16K 31/502; F16K 99/0034

(57) ABSTRACT

A microfluidic flow rate regulator can precisely control the fluid flow rate. When direct the fluid passing through the length-adjustable annular channel with a very thin gap inside the apparatus, the resistance generated by the fluid viscosity will slowdown the fluid flow rate; by adjusting the length of the length-adjustable annular channel, also changes the sum of the resistance that generated by the fluid viscosity and changed the fluid flow rate.

### REFERENCES CITE IN THE FILE OF THIS PATENT

UNITED STATES PATENTS

| | |
|---|---|
| U.S. Pat. No. 5,234,413 Terry M. Wonder | 1993 Aug. 10 |
| 6,619,311B2 Stephen D. O'Connor | 2003 Sep. 16 |
| 20070122314A1 David Strand | 2006 Aug. 3 |
| 20070272309 Jason Rehm | 2007 Nov. 29 |
| 7,413,712B2 Jian Liu Carl L | 2008 Aug. 19 |
| 7,537,739 Alfred Haas | 2009 May 26 |
| 20130081726A1 Seik OH | 2011 Oct. 3 |
| 8,105,783B2 Kalyan Handique | 2012 Jan. 31 |
| 20050192538 James Voege | 2012 Apr. 3 |
| 20120329681 Chuan Gao | 2012 Jun. 15 |
| 8,210,209B2 John R. Gilbert | 2012 Jul. 3 |
| 20110186652 Amir Cohen | 2012 Nov. 27 |
| 8,512,502B2 Lincoln C. Young | 2013 Aug. 20 |
| 8,765,076B2 Kalyan Handique | 2014 Jul. 1 |
| 9,364,829 Christian A. Heid | 2016 Jun. 14 |
| 20130178805 Rishi Baid | 2017 Dec. 19 |
| 10119619B2 Peng Zhou | 2018 Nov. 6 |

FOREIGN PATENT DOCUMENTS

| | |
|---|---|
| AU762045B2 Marja Liisa | 2003 Jun. 19 |
| EP1804150B1 Hun-Joo | 2010 Jan. 13 |
| EP2047910B1 Darren R. Link | 2012 Jan. 1 |

### BACKGROUND OF THE INVENTION

There are a numerous of microfluidic flow, particularly fluid flow regulating device of the prior art, is to change the size of the valve value for fluid flow path through inside the apparatus, or to narrow the nozzle by pressing the catheter externally for fluid flow path through inside the apparatus, or direct fluid flow path through the different length of narrow tubes inside the apparatus, or direct fluid flow path through the different diameter of narrow tubes inside the apparatus. These fluid flow rate regulating apparatus change the cross-sectional area of the fluid flow path or change the route length of the fluid flow path to control the fluid flow rate.

However, such knowns fluid flow regulating apparatus are often very complicated in operation and the fluid flow rate is unstable especially when require extremely low fluid flow output. For example, when requesting lower fluid flow output, the cross-sectional area of the fluid flow path needs to be narrower, or extend the route length for the fluid flow to pass through. The smaller cross-sectional area of the fluid flow path is not easy to adjust the different size and to control the nuance fluid flow rate; the longer fluid flow route need bigger space of the apparatus and the curve of these routes will cause accuracy error. These fluid flow paths are difficult to control the accuracy when require extremely low fluid flow output.

Therefore, it is necessary to develop a microfluidic flow rate regulator that can control the extremely low fluid flow rate and stable output. And easy install without any technical criteria. Just according to the indicator on the apparatus, the fluid flow rate can be accurately adjusted after installation.

### BRIEF SUMMARY OF THE INVENTION

This invention relates to a microfluidic flow rate regulator. More particularly, to present a fluid flow rate regulator, that precisely controls the fluid flow rate when directed the fluid flow passing through the length-adjustable annular channel with a very thin gap inside the apparatus, the resistance generated by the fluid viscosity will slow down the fluid flow rate, and when directed the fluid flow passing through the length-adjustable annular channel, by adjusting the length of the length-adjustable annular channel, the sum of the resistance generated by the fluid viscosity will be changed, thereby changed the fluid flow rate.

One aspect of the invention provides a microfluidic flow rate regulator apparatus. The apparatus may comprise: a spiral sleeve; a magnetically nut is screwed on the outer thread of the spiral sleeve; a polished fine core that embedded with a magnet located inside of the spiral sleeve fluid inlet; when screwing the magnetically nut to the direction of the spiral sleeve fluid outlet, the magnetically nut will attract the magnet that embedded in the polished fine core then guide the polished fine core along an axial direction to inserted into the spiral sleeve fluid outlet; at the engagement between the spiral sleeve fluid outlet inner walls and the polished fine core outer walls, will form a length-adjustable annular channel with a very thin gap for the fluid flows to pass through.

In the foregoing apparatus, when directed the fluid flows pass through the length-adjustable annular channel, the resistance generated by the fluid viscosity will slow down the fluid flow rate.

Continuing in the foregoing apparatus, when the fluid flow is passing through the length-adjustable annular channel, by adjusting the magnetically nut position on the spiral sleeve outer thread, the depth of the polished fine core which inserted into the spiral sleeve fluid outlet will be changed and at the same time, it changes the length of the length-adjustable annular channel, which also changes the sum of the resistance generated by the fluid viscosity, thereby changing the fluid flow rate.

Accordingly, it is a primary object of the present invention to provide a microfluidic flow rate regulator, which contains to adjust the length of the length-adjustable annular channel is capable to change the nuance fluid flow rate inside the apparatus, thereby precisely provide a continuous and stable fluid flow output.

Another object of the present invention is a flow rate indicator on the spiral sleeve outer wall can show off the length of the length-adjustable annular channel inside this apparatus, the indicator is relative to the fluid flow rate, it will provide an accurate reference and guide the operator in adjusting the fluid flow rate correctly.

These and other concomitant advantages of the present invention will become more apparent from the description of the appended claims.

### BRIEF DESCRIPTION OF THE DRAWINGS

The present invention will be described in detail with reference to the accompanying drawings:

FIG. 1 illustrates a schematic perspective view of the microfluidic flow rate regulator according to the invention.

FIG. 2 illustrates a schematic side elevational view of the microfluidic flow rate regulator according to the invention.

FIG. 3 illustrates a schematic side cross-sectional view of the microfluidic flow rate regulator according to the invention.

FIG. 4 illustrates a schematic cross-sectional view of the length-adjustable annular channel was in the microfluidic flow rate regulator according to the invention.

FIG. 5 illustrates a schematic exploded perspective view of the microfluidic flow rate regulator according to the invention.

FIG. 6 illustrates a schematic by an example as the circular cross-section annular channel theoretical calculation formula of the microfluidic flow rate regulator according to the invention.

FIG. 7 illustrates a schematic compare the different flow rates by the examples as the different circular cross-section length-adjustable annular channel theoretical calculations results, relative to the different radius of the length-adjustable annular channel inner wall and the different length of the length-adjustable annular channel of the microfluidic flow rate regulator according to the invention.

### DETAILED DESCRIPTION OF THE INVENTION

An embodiment of the present invention relates to the microfluidic flow rate regulator for the precision meter of the microfluidic flow rate and the method of its fabrication.

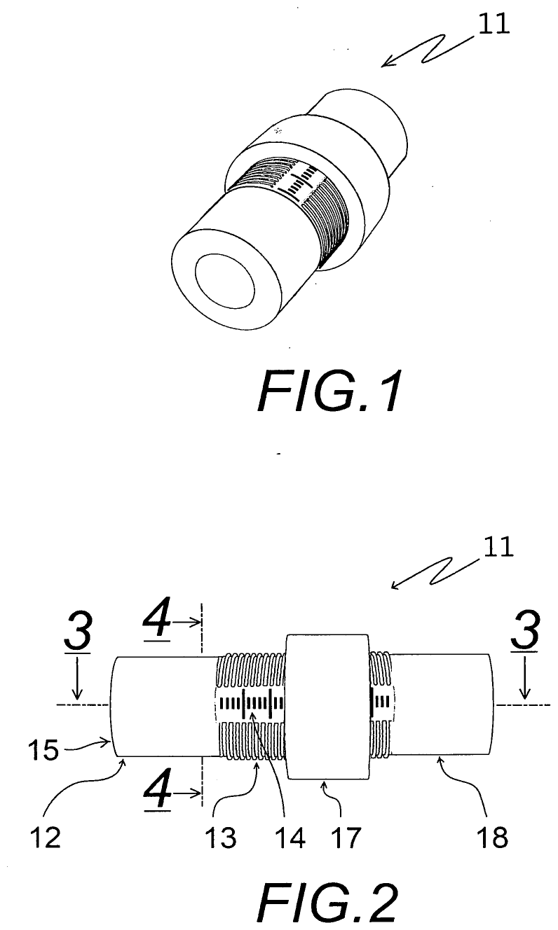

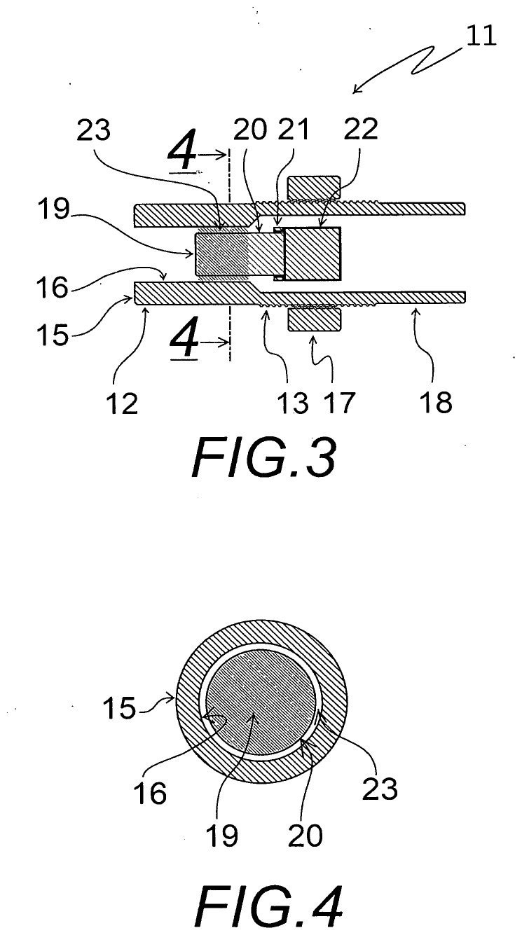

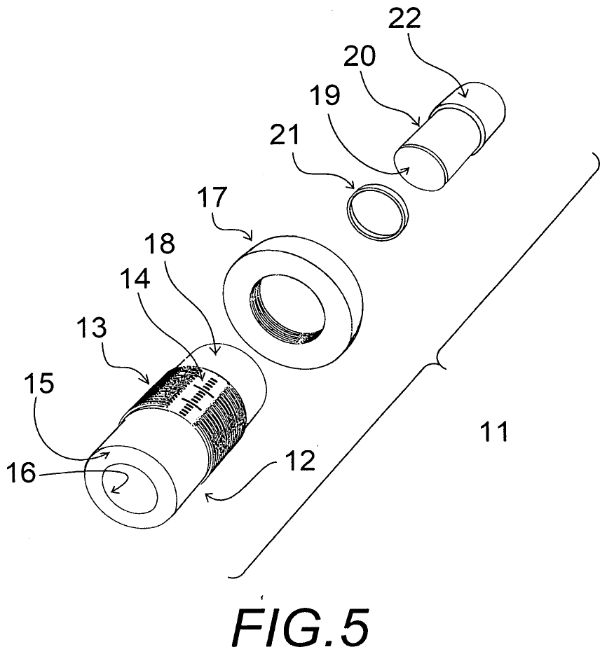

Referring to FIG. 1, FIG. 2, FIG. 3, FIG. 4 and FIG. 5, generally, according to the present invention, the optimal microfluidic flow rate regulator 11 comprises a spiral sleeve 12; a magnetically nut 17 is screwed on the outer thread 13 of the spiral sleeve 12; a polished fine core 19 that embedded with a magnet 22 located inside of the spiral sleeve 12 fluid inlet 18; when screwing the magnetically nut 17 to the direction of the spiral sleeve 12 fluid outlet 15, the magnetically nut 17 will attract the magnet 22 that embedded in the polished fine core 19, then guide the polished fine core 19 along an axial direction to inserted into the spiral sleeve 12 fluid outlet 15; at the engagement between the fluid outlet inner wall 16 and the polished fine core outer wall 20, will form a length-adjustable annular channel 23 with a very thin gap for the fluid flows to pass through; when directed the fluid flows pass through the length-adjustable annular channel 23, the resistance generated by the fluid viscosity will slow down the fluid flow rate.

Referring to FIG. 2 and FIG. 3, generally, according to the present invention, when adjusting the magnetically nut 17 positions on the outer thread 13 of the spiral sleeve 12, it will attract the magnet 22 that embedded in the polished fine core 19, then guide the polished fine core 19 to adjust the depth which insert into the spiral sleeve 12 fluid outlet 15, and change the length of the length-adjustable annular channel 23, which also changes the sum of the resistance generated by the fluid viscosity when the fluid flows pass through the length-adjustable annular channel 23, thereby changing the fluid flow rate.

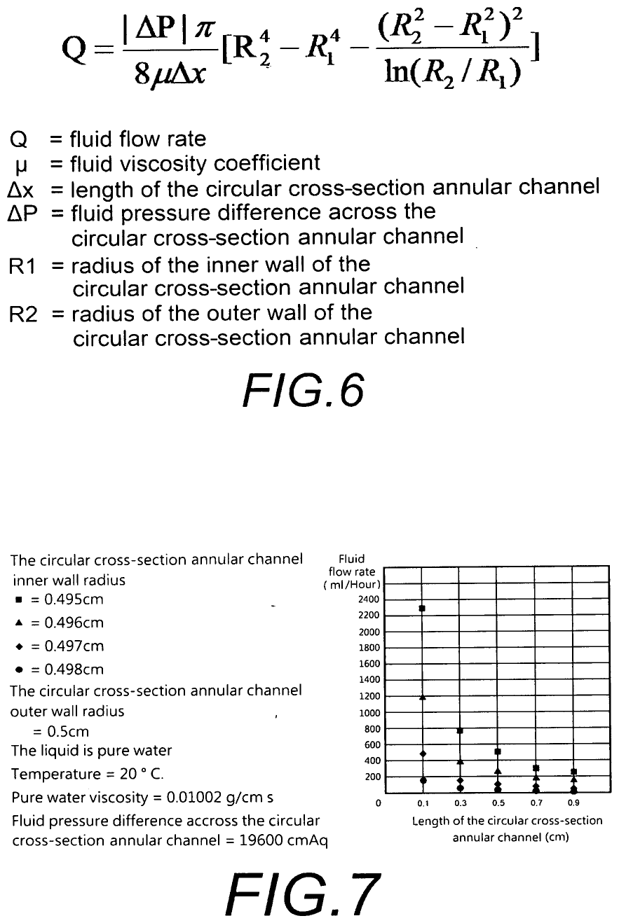

Referring to FIG. 2, FIG. 3, FIG. 6 and FIG. 7, generally, according to the present invention, referring to the theoretical calculations results, when adjusting the magnetically nut 17 positions on the outer thread 13 of the spiral sleeve 12, the flow rate indicator 14 will be covered by the magnetically nut 17, and the flow rate indicator 14 will show of the length of the length-adjustable annular channel 23 then according to the theoretical calculations to get the fluid flow rate.

Referring to FIG. 2 and FIG. 3, generally, according to the present invention, when screwing the magnetically nut 17 to the direction of the spiral sleeve 12 fluid outlet 15 to the limitation, the sealing rubber ring 21 which on the polished fine core 19 will block the length-adjustable annular channel 23, then stop the fluid flowing out.

Referring to FIG. 3, FIG. 4, FIG. 6 and FIG. 7, generally, according to the present invention, when using the different cross-sectional geometrical shapes of the fluid outlet inner wall 16 and the polished fine core outer wall 20, it will forms the different length-adjustable annular channel 23 and generate the various fluid flow rate character.

Referring to FIG. 2 and FIG. 3, generally, according to the present invention, the magnetically nut 17 can be made by a permanent magnet or electromagnetic coil to fit the different operation request.

### LIST OF REFERENCE NUMERALS

11 microfluidic flow rate regulator
12 spiral sleeve
13 outer thread
14 flow rate indicator
15 fluid outlet
16 fluid outlet inner wall
17 magnetically nut
18 fluid inlet
19 polished fine core
20 polished fine core outer wall
21 sealing rubber ring
22 magnet
23 length-adjustable annular channel

1. A microfluidic flow rate regulator apparatus comprising:
a spiral sleeve with fluid inlet configured to receive fluid into the apparatus and fluid outlet configured to discharge the fluid from the apparatus; a magnetically nut is screwed on the outer thread of the spiral sleeve; a polished fine core that embedded with a magnet located inside of the spiral sleeve fluid inlet; when screwing the magnetically nut to the direction of the spiral sleeve fluid outlet, the magnetically nut will attract the magnet that embedded in the polished fine core then guide the polished fine core along an axial direction to inserted into the spiral sleeve fluid outlet; at the engagement between the spiral sleeve fluid outlet inner wall and the polished fine core outer wall, will form a length-adjustable annular channel with a very thin gap for the fluid flows to pass through; when directed the fluid flows pass through the length-adjustable annular channel, the resistance generated by the fluid viscosity will slow down the fluid flow rate; when adjusting the magnetically nut positions on the outer thread of the spiral sleeve, it will attract the magnet that embedded in the polished fine core, then guide the polished fine core to adjust the depth which insert into the spiral sleeve fluid outlet, and change the length of the length-adjustable annular channel, when directed the fluid flows pass through the length-adjustable annular channel and by changing the length of the length-adjustable annular channel with a very thin gap, the sum of the resistance generated by the fluid viscosity will be changed, thereby changed the fluid flow rate; when using the different geometrical shapes of the fluid outlet inner wall and the polished fine core outer wall, it will generate the various fluid flow rate character; the magnetically nut can be made by a permanent magnet or electromagnetic coil to fit the different operation request.

2. The microfluidic flow rate regulator according to claim 1, further comprising when directed the fluid flows pass through the length-adjustable annular channel with a very thin gap, the fluid flow rate can be slow down by the resistance generated by the fluid viscosity.

3. The microfluidic flow rate regulator according to claim 1, further comprising when directed the fluid flows pass through the length-adjustable annular channel, by changing the length of the length-adjustable annular channel with a very thin gap, the sum of the resistance generated by the fluid viscosity will be changed and changed the fluid flow rate.

4. The microfluidic flow rate regulator according to claim 1, further comprising using the different cross-sectional geometrical shapes of the fluid outlet inner wall and the polished fine core outer wall to forms the different length-adjustable annular channel cross-sectional can generate the various fluid flow rate character.
